(19) United States
(12) Patent Application Publication
(10) Pub. No.: US 2005/0060188 A1
(43) Pub. Date: Mar. 17, 2005

(54) System, method, and computer program product for health care patient and service management

(75) Inventor: LeRoy R. Valley, Bay City, MI (US)

Correspondence Address: DOCKET CLERK, DM/EDS, P.O. DRAWER 800889, DALLAS, TX, 75380, US

(73) Assignee: ELECTRONIC DATA SYSTEMS CORPORATION, Plano, TX (US)

(21) Appl. No.: 10/654,594

(22) Filed: Sep. 3, 2003

(51) Int. Cl. G06F 17/60

(52) U.S. Cl. 705/2

(57) ABSTRACT

A system and method for traceability and accountability in a healthcare environment. Individual patient identifiers, preferably in the form of barcodes, are used to identify substantially every pharmaceutical, test sample, and individual involved with the patient's treatment. As the patient is treated, the identifying barcode of substantially every treating individual, drug, or other object or process are scanned an associated with the patient's identifier, and patient-specific barcodes are also printed on demand to immediately label any test sample, report, or other object associated with the patient.

### TECHNICAL FIELD OF THE INVENTION

The present invention is directed, in general, to healthcare patient and service management.

### BACKGROUND OF THE INVENTION

The health care industry is one in which any error can be costly or even deadly. It is of crucial importance to be able to monitor the status and treatment of each patient, as well as to ensure that drugs, charts, samples, and other things are associated with the proper patient.

Unfortunately, there is very little error proofing and traceability in place today, and what does exist is typically manual and/or visual—both of which are error-prone. This has been proven to be a recipe for errors in numerous industries.

Errors in the medical community equate to disasters—both to the patients, and to the institutions bottom line. The news regularly reports on mistakes made with regards to:

Incorrect type and or amount of medication administered;
Surgical procedures performed on the wrong patient, or on the wrong area of the right patient (i.e.—operated on the left knee instead of the right);
Blood type mismatch;
Patient allergies; and many others.

In many of these cases, the well being of the patient is directly affected, with the end result ranging in severity from ongoing health issues to death. These mistakes often result in very costly law suits to the institutions involved. The majority of these errors can be directly linked to two main causes: Incomplete or unavailable patient information and human error due to manual or visual verification.

There is, therefore, a need in the art for an improved system, method, and computer program product for health care patient and service management.

### SUMMARY OF THE INVENTION

The preferred embodiment provides a system and method for traceability and accountability in a healthcare environment. Individual patient identifiers, preferably in the form of barcodes, are used to identify substantially every pharmaceutical, test sample, and individual involved with the patient's treatment. As the patient is treated, the identifying barcode of substantially every treating individual, drug, or other object or process are scanned and associated with the patient's identifier, and patient-specific barcodes are also printed on demand to immediately label any test sample, report, or other object associated with the patient.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art will appreciate that they may readily use the conception and the specific embodiment disclosed as a basis for modifying or designing other structures for carrying out the same purposes of the present invention. Those skilled in the art will also realize that such equivalent constructions do not depart from the spirit and scope of the invention in its broadest form.

Before undertaking the DETAILED DESCRIPTION OF THE INVENTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 depicts a block diagram of a data processing system network in which a preferred embodiment can be implemented;

FIG. 2 depicts a data processing system in which a preferred embodiment of the present invention may be implemented, as any of the disclosed data processing systems;

FIG. 3 depicts a flowchart of a process in accordance with the preferred embodiment; and

FIG. 4 depicts a flowchart of a process in accordance with the preferred embodiment.

### DETAILED DESCRIPTION OF THE INVENTION

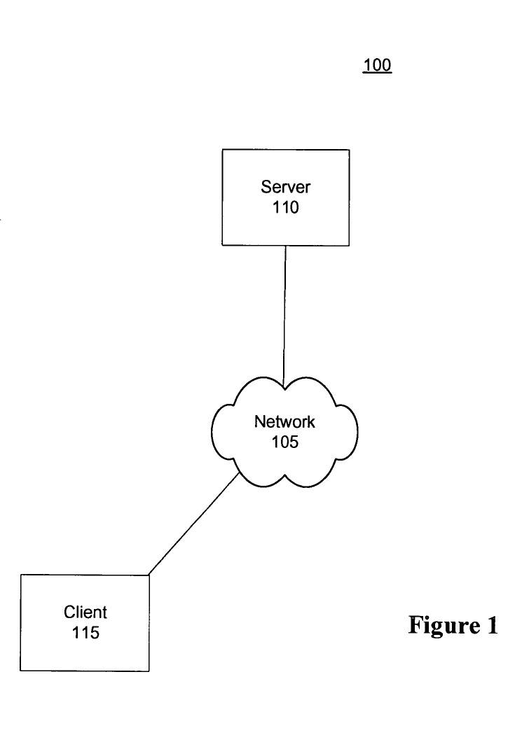

FIGS. 1 through 4, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged device. The numerous innovative teachings of the present application will be described with particular reference to the presently preferred embodiment.

The preferred embodiment provides a system and method for traceability and accountability in a healthcare environment. Individual patient identifiers, preferably in the form of barcodes, are used to identify substantially every pharmaceutical, test sample, and individual involved with the patient's treatment. As the patient is treated, the identifying barcode of substantially every treating individual, drug, or other object or process are scanned and associated with the patient's identifier, and patient-specific barcodes are also printed on demand to immediately label any test sample, report, or other object associated with the patient.

FIG. 1 depicts a block diagram of a data processing system network in which a preferred embodiment can be implemented. Network system 100 can be implemented in any type of public or private computer network, and can be implemented by data processing systems connected by telephone line, a local-area-network, a wide-area-network, by Ethernet, fiber optic cable, wireless, WiFi, or any other known means.

Server 110 is connected to network system 105, and can thereby communicate with client system 115.

Client system 115 can be a general-purpose data processing system in desktop or laptop form, as described herein, or can be implemented in a PDA, handheld data processing system, or special-purpose device. Important features of the client system 115 are the ability to scan and/or print identifying tags, preferably barcodes, and the ability to communicate with server 110. It should be noted that typically many other data processing systems will be connected to network system 105, including multiple client systems and multiple server systems.

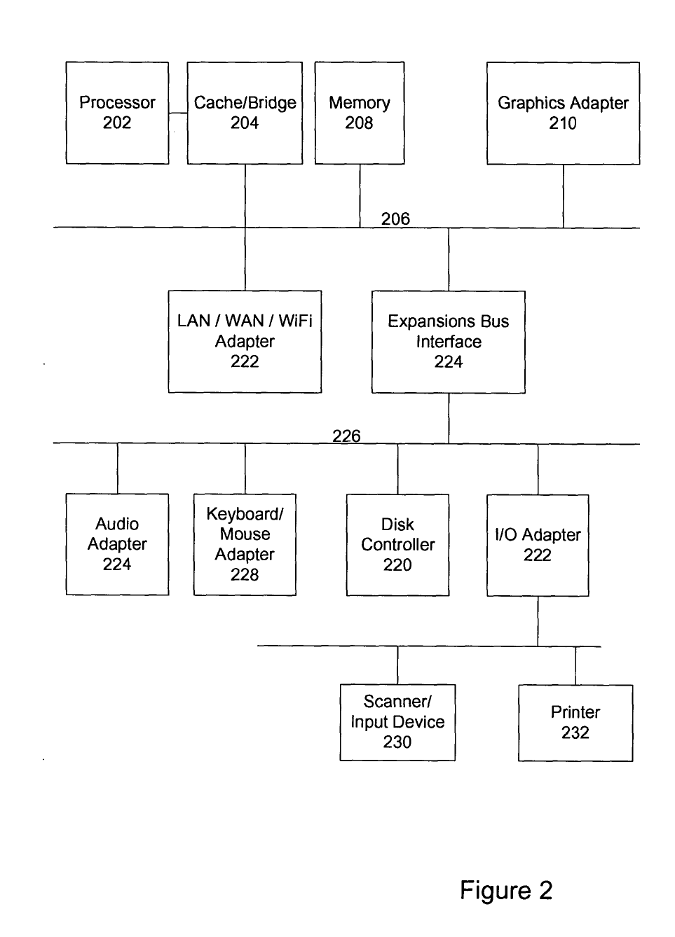

FIG. 2 depicts a data processing system in which a preferred embodiment of the present invention may be implemented, as any of the disclosed data processing systems. The data processing system depicted includes a processor 202 connected to a level two cache/bridge 204, which is connected in turn to a local system bus 206. Local system bus 206 may be, for example, a peripheral component interconnect (PCI) architecture bus. Also connected to local system bus in the depicted example are a main memory 208 and a graphics adapter 210.

Other peripherals, such as local area network (LAN)/Wide Area Network/Wireless (e.g. WiFi) adapter 212, may also be connected to local system bus 206. Expansion bus interface 214 connects local system bus 206 to input/output (I/O) bus 216. I/O bus 416 is connected to keyboard/mouse adapter 218, disk controller 220, and I/O adapter 222.

Also connected to I/O bus 216 in the example shown is audio adapter 224, to which speakers (not shown) may be connected for playing sounds. Keyboard/mouse adapter 218 provides a connection for a pointing device (not shown), such as a mouse, trackball, trackpointer, etc.

Connected to I/O adapter 222 is scanner/input device 230, for reading identifier tags, which are barcodes in the preferred embodiment, and printer 232, which is capable of printing identifier tags, including barcodes, on demand.

Those of ordinary skill in the art will appreciate that the hardware depicted in FIG. 2 may vary for particular. For example, other peripheral devices, such as an optical disk drive and the like, also may be used in addition or in place of the hardware depicted. The depicted example is provided for the purpose of explanation only and is not meant to imply architectural limitations with respect to the present invention.

A data processing system in accordance with a preferred embodiment of the present invention includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present invention as described.

The preferred embodiment provides patient traceability and error proofing from admittance to discharge. By integrating technologies such as centralized data storage, linear and 2d barcode identification, wireless networks, on-demand barcode printing, and automated data retrieval from test equipment, this system significantly reduces the opportunity for human error, and reduces the amount of time required for data collection for each patient.

The preferred embodiment provides means for covering multiple areas during a patient's stay, including:

Admittance—When a patient arrives at the hospital, a unique wristband is generated. Depending on symbology, this wristband contains various information. For example, when a linear barcode symbology (Code 39 or 128) is used, the information includes patient identification and a link to the patient's online medical history.

When 2D barcode symbology (PDF417, MicroPDF417, or Data Matrix) is used, the information includes patient identification, critical information such as blood type, allergies, reason for current visit, primary doctor, health insurance, etc., and a link to the patient's online medical history.

Using a scannable 2D barcode, or alternately a radio-frequency identification (RFID) tag, much of the patients critical medical facts and history could be completely contained within an easily portable form. Thus, the patient can carry their his history with him, perhaps on a scannable/readable card. This would be invaluable for emergency treatment, treatment away from home, or future visits with new health professionals.

In addition, to meet federal privacy regulations, the data could also be encoded or encrypted to provide secure access to said data.

Patient Traceability—During the patient's stay, all care given would be verified and recorded by the system. Each time a service is rendered to the patient, a standardized process would be followed. Basic steps are to scan the patient's ID, then scan the care giver's ID, which provides record of who performed service, and finally, provide the service step.

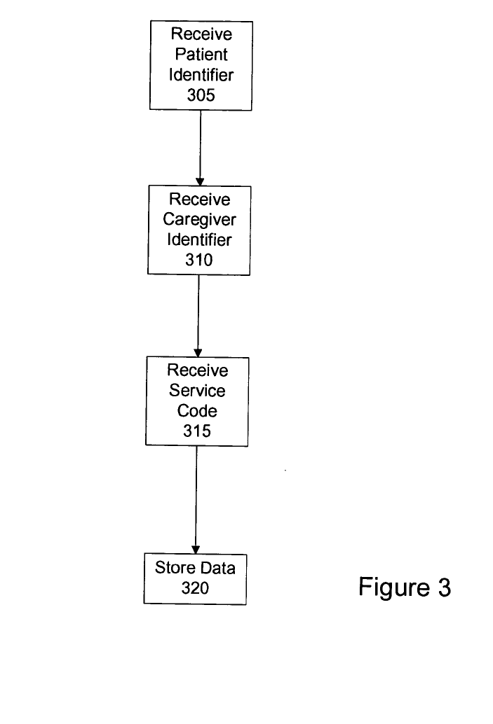

The process performed by the system is shown in FIG. 3. The system will receive the patient identifier (step 305), then receive the caregiver/employee identifier (stop 310). The system will receive the service code for the type of service being performed (step 315). Finally, the employee identifier and service type is stored in association with the patient identifier (step 320).

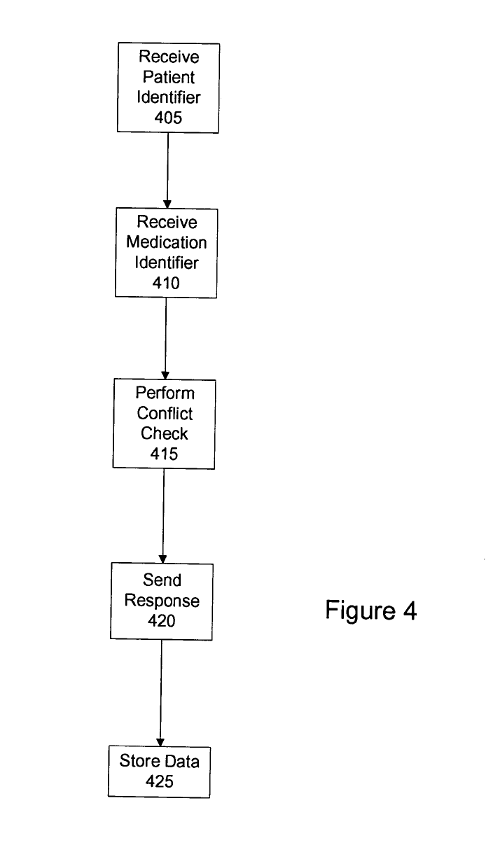

One example of this is medication dispensation, wherein each medication drawer in the medication table would be labeled for each patient. By scanning the patient ID and the medication drawer, the system verifies correct type and dosage. The system alerts as to allergies or issues. This process is illustrated in FIG. 4. Here, the system will receive the patient identifier (step 405), the system will receive a medication identifier, which can also include dosage data (step 410). The system will perform a check for medication/allergy/other issue conflicts (step 415). The system will then send a response, indicating an approval or warning regarding the medication (step 420). If approved, the system will store that the medicine has been dispensed (step 425).

Another example is round verification, in which the preferred method is used to keep and maintain a permanent record of who made rounds and when.

Sample Identification—Whenever a service is performed that requires a positive link back to the patient, a barcoded label would be generated on-demand, at point of use. An example of this would be when blood is drawn from a patient. Preferably, the health care practitioner follows a standardized process:

Scan the patient's ID; Scan the care giver's ID (provides record of who performed service); Select the service to be performed on the scanner; Draw the blood; System would print a barcode label to place on the sample. This barcode label would be directly linked to the patient's ID. This label can now be used to error-proof the testing process. Other examples include labeling x-rays and test results.

Lab Results—Any diagnosis or tests performed on blood, tissue samples, MRI's, etc., can be error proofed using the improved system and method. The test or diagnosis follows a standard process:

Scan the sample ID; Scan the care giver's ID (provides record of who performed service); Select the service to be performed on the scanner; Perform the service (test or diagnosis); Record results in system (Note: Depending on equipment capability, these results could be automatically recorded, thus eliminating human error); Result printout would include Patient ID.

Surgical Verification—Once a patient is brought into surgery, verification could be made as to correct patient, surgical procedure, OR room, and surgeon. This would follow a standard process:

Scan the Patient ID; Scan all care givers' IDs. (Provides record of surgical team that performed service); Display patient information and surgical procedure to be performed; Perform the surgery.

Wireless/Remote Access—Patient data is accessible on handheld devices via a local 802.11b wireless infrastructure, or remotely via a cellular or dial-in connection, or by any other known wireless, wireline, or network connection. This allows real time patient status at any location in the hospital, instant delivery of critical messages, consultation with off-site doctors and surgeons with real time access to patient information via remote connection, and availability of patient information while doctors are enroute to hospital for critical cases, among other uses.

Discharge/Billing—Upon discharge, billing is generated automatically, following a standard process: scan the Patient ID; scan the caregiver's ID, which provides record of who handled discharge; set patient status to “discharge” and generate bill based on all services performed against Patient ID.

Some particular characteristics of HITS include centralized storage of patient data, a standardized method of storing patient data that enables movement of patient data between health institutions, access to patient data is strictly controlled through the use of a version control engine (e.g., Microsoft Visual SourceSafe), and patient traceability from admittance to discharge. This traceability includes patient identification with unique bar code, time, date, description, and care giver recorded for each procedure administered, medication administered. Further, verification insures that processes are followed rigorously, and on time. Real time patient status is available via wireless, cellular, and land based communications, as well as is instant delivery of critical messages. 2D bar code identification of patient serves as a portable record and includes critical patient history and information.

The preferred embodiment provides error proofing and verification of procedures, medication, and routes, and further provides alarm capabilities based on pre-defined rules. Examples include allergy alerts, time exceeded between patient checks, and dosage limits for medication. These alarms could be visual, audible, or both. Alarm system supports paging.

Additional features include on-demand printing of identification labels for patient samples (i.e. blood, tissue, etc.), automated collection of lab test data, immediate access to lab test data, surgical procedure verification, and automated patient billing.

Individual components or modules of the system could be implemented with a variety of technologies. Some alternate embodiments include:

1. Using a linear 1D barcode linked to a patient history database can operate as the equivalent of a portable patient history contained within a 2D barcode. This embodiment has a disadvantage in that the data would be unavailable in a number of instances: database is down, communications are down or unavailable at the instant location, the scanning device can't login, etc. The self-contained 2D portable patient history would still provide critical information in these circumstances.

2. On-demand printing of identification labels can be replaced with batch printing of identification labels. Batch printing indicates that the labels have been generated prior to use, and thus introduces an opportunity for human error. On-demand printing indicates generation of a unique label at point of use, and reduces the opportunity for error.

3. Land based connections for transmission and retrieval of data can be used as opposed to wireless or cellular communications. This would be less costly to implement on a local basis, but is less practical for wide spread implementations. This approach also limits where and how data can be accessed.

4. Patient data could be stored in a proprietary, non-standard format. This would limit the usefulness and accessibility of the data, and would restrict the use of the data across multiple systems.

Those skilled in the art will recognize that, for simplicity and clarity, the full structure and operation of all data processing systems suitable for use with the present invention is not being depicted or described herein. Instead, only so much of a data processing system as is unique to the present invention or necessary for an understanding of the present invention is depicted and described. The remainder of the construction and operation of data processing system 100 may conform to any of the various current implementations and practices known in the art.

Further, those of skill in the art will recognize that various steps in processes described herein do not necessarily have to be performed in the order recited. In particular, when multiple data is received in various steps, it is clear that the data can be received in any order without effecting the function of the process.

It is important to note that while the present invention has been described in the context of a fully functional system, those skilled in the art will appreciate that at least portions of the mechanism of the present invention are capable of being distributed in the form of instructions contained within a machine usable medium in any of a variety of forms, and that the present invention applies equally regardless of the particular type of instruction or signal bearing medium utilized to actually carry out the distribution. Examples of machine usable mediums include: nonvolatile, hard-coded type mediums such as read only memories (ROMs) or erasable, electrically programmable read only memories (EEPROMs), user-recordable type mediums such as floppy disks, hard disk drives and compact disk read only memories (CD-ROMs) or digital versatile disks (DVDs), and transmission type mediums such as digital and analog communication links.

Although an exemplary embodiment of the present invention has been described in detail, those skilled in the art will understand that various changes, substitutions, variations, and improvements of the invention disclosed herein may be made without departing from the spirit and scope of the invention in its broadest form.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC §112 unless the exact words “means for” are followed by a participle.

1. A method for managing health services, comprising:
receiving a patient identifier that identifies a patient;
receiving a caregiver identifier that identifies an individual performing a health service;
receiving a service identifier that identifies the health service performed for the patient;
associating the patient identifier with the caregiver identifier and the service identifier; and
storing the patient identifier, the caregiver identifier, and the service identifier.

2. The method of claim 1, wherein the patient identifier and caregiver identifier are received by scanning a barcode.

3. The method of claim 1, wherein the caregiver identifier and the service identifier are used to track any services performed for a patient identified by the patient identifier.

4. A method for managing health services, comprising:
receiving a patient identifier that identifies a patient;
receiving a medication identifier that identifies a medication to be dispensed to the patient;
determine if any conflicts exist between the patient and the medication;
sending a response indicating the whether any conflicts exist between the patient and the medication; and
storing the patient identifier, the medication identifier, and an indicator as to whether the medication is to be dispensed to the patient.

5. The method of claim 4, wherein the patient identifier and medication identifier are received by scanning a barcode.

6. The method of claim 4, wherein the medication identifier includes dosage data.

7. The method of claim 4, wherein the conflicts include allergic reactions.

8. A data processing system having at least a processor and accessible memory, comprising:
means for receiving a patient identifier that identifies a patient;
means for receiving a caregiver identifier that identifies an individual performing a health service;
means for receiving a service identifier that identifies the health service performed for the patient;
means for associating the patient identifier with the caregiver identifier and the service identifier; and
means for storing the patient identifier, the caregiver identifier, and the service identifier.

9. The data processing system of claim 8, wherein the patient identifier and caregiver identifier are received by scanning a barcode.

10. The data processing system of claim 8, wherein the caregiver identifier and the service identifier are used to track any services performed for a patient identified by the patient identifier.

11. A data processing system having at least a processor and accessible memory, comprising:
means for receiving a patient identifier that identifies a patient;
means for receiving a medication identifier that identifies a medication to be dispensed to the patient;
means for determine if any conflicts exist between the patient and the medication;
means for sending a response indicating the whether any conflicts exist between the patient and the medication; and
means for storing the patient identifier, the medication identifier, and an indicator as to whether the medication is to be dispensed to the patient.

12. The data processing system of claim 11, wherein the patient identifier and medication identifier are received by scanning a barcode.

13. The data processing system of claim 11, wherein the medication identifier includes dosage data.

14. The data processing system of claim 11, wherein the conflicts include allergic reactions.

15. A computer program product tangibly embodied in a computer-readable medium, comprising:
instructions for receiving a patient identifier that identifies a patient;
instructions for receiving a caregiver identifier that identifies an individual performing a health service;
instructions for receiving a service identifier that identifies the health service performed for the patient;
instructions for associating the patient identifier with the caregiver identifier and the service identifier; and
instructions for storing the patient identifier, the caregiver identifier, and the service identifier.

16. The computer program product of claim 15, wherein the patient identifier and caregiver identifier are received by scanning a barcode.

17. The computer program product of claim 15, wherein the caregiver identifier and the service identifier are used to track any services performed for a patient identified by the patient identifier.

18. A computer program product tangibly embodied in a computer-readable medium, comprising:
instructions for receiving a patient identifier that identifies a patient;
instructions for receiving a medication identifier that identifies a medication to be dispensed to the patient;
instructions for determine if any conflicts exist between the patient and the medication;
instructions for sending a response indicating the whether any conflicts exist between the patient and the medication; and
instructions for storing the patient identifier, the medication identifier, and an indicator as to whether the medication is to be dispensed to the patient.

19. The computer program product of claim 18, wherein the patient identifier and medication identifier are received by scanning a barcode.

20. The computer program product of claim 18, wherein the medication identifier includes dosage data.

21. The computer program product of claim 18, wherein the conflicts include allergic reactions.
